(19) United States
(12) Patent Application Publication
(10) Pub. No.: US 2021/0329856 A1
(43) Pub. Date: Oct. 28, 2021

(54) SIMPLIFIED CULTIVATION METHOD WITHOUT WHEAT-CORN ROTATION SYSTEM IN HUANG-HUAI-HAI PLAIN

(71) Applicant: CROP RESEARCH INSTITUTE, SHANDONG ACADEMY OF AGRICULTURAL SCIENCES, Jinan (CN)

(72) Inventors: Kaichang LIU, Jinan (CN); Zongxin LI, Jinan (CN); Haijun ZHAO, Jinan (CN); Shengdong LI, Jinan (CN); Ping LIU, Jinan (CN)

(21) Appl. No.: 17/232,040

(22) Filed: Apr. 15, 2021

(30) Foreign Application Priority Data
Apr. 27, 2020 (CN) 202010345189.3

(51) Int. Cl. A01G 22/20

(52) U.S. Cl. CPC A01G 22/20

(57) ABSTRACT

The present disclosure relates to a simplified cultivation method without wheat-corn rotation system in Huang-huai-hai Plain. Aiming at making the most of regional light, temperature and water resources to increase the annual wheat-corn grain yield, the method optimally integrates cultivation technologies for two crops to achieve the objective of complementary, comprehensive and balanced annual grain production. The technical core of the method is as follows: directly planting corn with minimal tillage under no soil ploughing but straw mulching after corn harvest, and directly planting wheat with minimal tillage under no soil ploughing but straw mulching after wheat harvest, thereby realizing zero crop rotation in annual wheat-corn planting in the Huang-huai-hai Plain, making the most of light and temperature resources and increasing regional annual grain yield.

### CROSS-REFERENCE TO RELATED APPLICATIONS

This application is a claims priority to Chinese Application No. 202010345189.3, filed Apr. 27, 2020, under 35 U.S.C. § 119(a). The above-referenced patent application is incorporated by reference in its entirety.

### BACKGROUND OF THE INVENTION

### Field of the Invention

The present disclosure relates to a cultivation method for simplification of annual wheat-corn planting in Huang-huai-hai Plain and efficient utilization of light and temperature resources.

### Description of the Related Technology

Disclosure of the background information is only intended to increase some understanding of the general background of the present disclosure, and is not necessarily deemed as an acknowledgement or in any form implying that the information constitutes the prior art known to those of ordinary skill in the art.

Double cropping of wheat and corn is a main grain production system in the Huang-huai-hai Plain. Before 2000, influenced by the level of agricultural mechanization, the production system mainly used corn interplanting, that is, corn interplanting rows were reserved when wheat is planted, and corn was seeded manually in hills of the reserved interplanting rows when wheat harvest was approaching. This technology played an important role at a low level of agricultural mechanization at that time. By 2005, with the improvement of the mechanization level in the production of wheat and corn in the Huang-huai-hai Plain, corn seeding gradually realized the change from manual hill seeding to mechanical direct seeding. This change not only increased the density and uniformity of corn, and grain output, but also liberated abundant labor force from agricultural production. However, with the popularization and application of direct seeding technology of corn, the problem of insufficient light and temperature resources of annual wheat and corn crops in the Huang-huai-hai Plain has gradually emerged. That is, if the wheat is seeded after the corn is fully ripe, the wheat may be very likely to miss the optimal seeding time and cannot form strong seedlings before the arrival of winter. On the contrary, if the wheat is allowed to undergo a complete growth process, corn production will be influenced. Against this background, some scientists use wheat and corn cultivars with shorter growth periods to achieve annual high yields. However, the yield and quality of these cultivars are inferior to those of conventionally planted cultivars. Therefore, the actual promotion and application effects thereof are poor.

In conventional production, after corn harvest and before wheat seeding, there are generally eight processes: rotary tillage for straw chopping, farmland ploughing, spreading of seed fertilizer, rotary tillage for soil crushing, leveling, bedding, seeding, and tamping, which consume a lot of farming seasons. After wheat harvest, a corn stubble seeder is directly used to sow corn between straw rows in the wheat field. Because the corn is subjected to direct stubble seeding and is planted just in the dry season, it is difficult to guarantee the emergence rate and uniformity of corn, limiting the exertion of yield potential of corn cultivars.

### SUMMARY

In view of the above problems, starting from reducing the idle period of corn sowing after wheat harvest and wheat sowing after corn harvest, the present disclosure fully exerts the existing light and temperature production resources of the Huang-huai-hai Plain. Under this condition, the present disclosure improves annual light and temperature resource production efficiency and annual grain output by realizing direct corn seeding immediately after wheat harvest and direct wheat seeding immediately after corn harvest.

Aiming at making the most of regional light and temperature resources to increase the annual wheat-corn grain yield, the simplified cultivation method without wheat-corn rotation system in Huang-huai-hai Plain optimally integrates cultivation technologies for two crops to achieve the objective of complementary, comprehensive and balanced annual grain production. The technical core of the method is as follows: directly planting corn with minimal tillage under no soil ploughing but straw mulching after corn harvest, and directly planting wheat with minimal tillage under no soil ploughing but straw mulching after wheat harvest, thereby realizing zero crop rotation in annual wheat-corn planting in the Huang-huai-hai Plain, making the most of light and temperature resources and increasing regional annual grain yield.

Specifically, the present disclosure adopts the following technical solution:

a simplified cultivation method without wheat-corn rotation system in Huang-huai-hai Plain, including the following steps:

The simplified cultivation method without wheat-corn rotation system in Huang-huai-hai Plain changes eight processes (rotary tillage for straw chopping, farmland ploughing, spreading of seed fertilizer, rotary tillage for soil crushing, leveling, bedding, seeding, and tamping) after corn harvest in conventional production to one-step process of leveling and seeding in a wheat seedbed, that is, the wheat is seeded on the day or the next day after corn harvest; for corn planting, conventional direct stubble seeding of corn is changed to leveling and seeding in a corn seedbed, that is, the wheat is planted on the day or the next day after wheat harvest; zero crop rotation in wheat-corn planting is realized.

In a preferred example of the present disclosure, the wheat may be seeded on the day or the next day after corn harvest; and the corn may be seeded on the day or the next day after wheat harvest.

In a preferred example of the present disclosure, a no-tillage fertile-seeding drill may be used for completing the process of leveling and seeding in the wheat seedbed.

Further preferably, 2BMF Wheat No-tillage Planter (Shandong Dahua Machinery Co., Ltd.) may be used.

For many years, the inventors have been engaged in the production, research and technical development of wheat and corn. Based on the above ideas, the inventors have conducted in-depth research and analysis on technical parameters of wheat planting. After years of research and practice, a set of more preferred technical parameters for wheat planting are obtained. These technical parameters have an important influence on regional annual grain yield, and specifically include as follows: subsoiling depth of seedbed is 27-29 cm; finishing depth of seedbed is 11-13 cm; seedbed width is 17-19 cm; two rows of wheat are seeded in the seedbed, with a row spacing of 9-11 cm; both sides of the seedbed are undisturbed soil, with a width of 11-13 cm; wheat seeding depth is 3.5-4.5 cm; fertilization depth of seed fertilizer is 9-11 cm, and the fertilizer is applied 2.5-3.5 cm lateral to a wheat seed. Verified by trials with the above planting parameters, light and temperature resources may be utilized to the utmost extent to increase the regional annual grain yield compared with other planting parameters.

Further, seedbed finishing standard means that bulk density of 11-13 cm deep soil may be preferably 1.1-1.2 g/cm³, and total soil porosity may be 54-56%.

Further preferably, the technical parameters of wheat planting may be as follows: the subsoiling depth of seedbed may be 28 cm; the finishing depth of seedbed may be 12 cm; the seedbed width may be 18 cm; two rows of wheat may be seeded in the seedbed, with a row spacing of 10 cm; single side or both sides of the seedbed may be undisturbed soil, with a width of 12 cm; the wheat seeding depth may be 4 cm; the fertilization depth of seed fertilizer may be 10 cm, and the fertilizer may be applied 3 cm lateral to a wheat seed.

In a preferred example of the present disclosure, a no-tillage fertile-seeding drill may be used for completing the leveling and seeding in the corn seedbed.

Further preferably, a Lovol MaterMacc vacuum precision planter may be used. With this planter, seedbed leveling, stubble cleaning, seeding, and fertilization (using slow-controlled fertilizer) may be completed in one operation.

Similarly, the inventors have conducted in-depth research and analysis on technical parameters of corn planting. After years of research and practice, a set of more preferred technical parameters of corn planting have been obtained: the subsoiling depth of corn seedbed is 19-21 cm; a row of corn is seeded in the seedbed; the seedbed width is 9-11 cm; single side or both sides of the seedbed are undisturbed soil, with a width of 34-36 cm; the row spacing of corn is 44-46 cm; the finishing depth of seedbed is 7-9 cm; the corn seeding depth is 2.5-3.5 cm; the fertilization depth of seed fertilizer is 14-16 cm, and the fertilizer is just applied below the corn seed. Verified by trials with the above planting parameters, light and temperature resources may be utilized to the utmost extent to increase the regional annual grain yield compared with other planting parameters.

Further preferably, the technical parameters of corn planting may be as follows: the subsoiling depth of corn seedbed may be 20 cm; a row of corn may be seeded in the seedbed; the seedbed width may be 10 cm; single side or both sides of the seedbed may be undisturbed soil, with a width of 35 cm; the finishing depth of seedbed may be 8 cm; the corn may have an equal row spacing, with a row spacing of 45 cm; the corn seeding depth may be 3 cm; the fertilization depth of seed fertilizer may be 15 cm.

Still more preferably, the fertilizer may be a slow-controlled fertilizer.

Further, seedbed finishing standard means that bulk density of 7-9 cm deep soil may preferably be 1.1-1.2 g/cm³, and total soil porosity may be 54-56%.

In the simplified cultivation method without wheat-corn rotation system in Huang-huai-hai Plain, farming season desired for conventional wheat seeding is changed from 10-15 days to 0 day. During corn sowing, the direct stubble seeding on hard soil is changed to seedbed subsoiling, leveling, and direct seeding. When zero crop rotation continues, corn seeding quality has been significantly improved, and the density and uniformity of the corn have been ensured, laying a foundation for high annual grain yield.

The key problems solved by the simplified cultivation method without wheat-corn rotation system in Huang-huai-hai Plain are as follows:

(1) The method solves the problems of cumbersome cultivation, multiple planting specifications, and poor coherence, complex field work, and low comparative profit of grain production in conventional production; the method realizes simplified wheat and corn planting with zero crop rotation, and increases utilization efficiency of annual light and temperature resources by more than 5% and grain yield by more than 7%.

(2) The method solves the problems of poor quality of corn population, low yield, and poor matching degree of climate resources in conventional production, realizes the improvement of the germination rate and uniformity of corn, and increases corn yield by 7%-15% compared with conventional production.

Compared with the prior art, the simplified cultivation method without wheat-corn rotation system in Huang-huai-hai Plain obtains the following beneficial effects:

(1) Combination of agricultural machinery with agriculture improves land utilization efficiency. An all-in-one drill for wheat subsoiling, minimal tillage, seeding and fertilization and an all-in-one drill for corn minimal tillage, seeding, leveling, and fertilization may unify a wheat-corn planting pattern, reduce rectangular pieces of land in a field, and increase the land use capability by about 6%.

(2) Quality seeds and excellent methods are matched to make full use of light and heat resources. The simplified cultivation method without wheat-corn rotation system in Huang-huai-hai Plain provided by the present disclosure may effectively avoid the problems of irregular seedlings and uneven seedlings in the wheat seeding link. In the later period, the field has good ventilation and transmittance, pests and diseases decrease, and resistance is improved, which is beneficial to later high yield. The corn may be seeded mechanically with single seed fertilizer, and the seedbed leveling, stubble cleaning, seeding, and fertilization (using slow-controlled fertilizer) may be completed in one operation with high efficiency. This may ensure the planting density, avoid rough dwarf disease, and save more than 10% of corn seed; while using slow-controlled corn fertilizer, chemical fertilizer consumption may be reduced, fertilizer use efficiency may be increased by more than 20%, productive efficiency of farmland moisture may be increased by 15%, and corn yield and quality may be improved.

(3) The level of mechanization is high, and the cost-saving and benefit-increasing effect is outstanding. This new planting pattern widely works by means of agricultural machinery to increase the level of mechanization, reduce labor, and truly save seeds, fertilizers, and labor. The planting pattern is recognized by farmers, especially large grain growers; after comprehensive calculation, income increases by more than RMB 350 yuan per mu, significantly improving the regional comparative profit of grain production.

### BRIEF DESCRIPTION OF THE DRAWINGS

The drawings constituting a part of the specification of the present disclosure are intended to provide a further understanding of the present disclosure. The exemplary examples and descriptions of the present disclosure are intended to explain the present disclosure, and should not be construed to unduly limit the present disclosure.

FIG. 1 is a schematic diagram of wheat seeding, where dotted lines in the box composed of thick solid lines represent center lines of wheat seeds.

FIG. 2 is a schematic diagram of corn seeding, wherein dotted lines represent the center lines of corn seeds.

### DETAILED DESCRIPTION

It should be noted that the following detailed descriptions are all exemplary and are intended to provide further descriptions of the present disclosure. Unless otherwise specified, all technical and scientific terms used herein have the same meaning as commonly understood by one of ordinary skill in the technical field to which the present disclosure belongs.

It should be noted that the terms used herein are only intended to describe specific examples, but not intended to limit the exemplary examples according to the present disclosure. As used herein, a singular form is intended to include a plural form unless otherwise indicated explicitly in the context. Furthermore, it should be further understood that the terms “includes” and/or “including” used in this specification specify the presence of features, steps, operations, and/or combinations thereof.

In order to enable those skilled in the art to understand the technical solution of the present disclosure more clearly, the technical solution of the present disclosure will be described in detail below with reference to specific examples.

### EXAMPLE 1

The example was carried out in a test field of the Crop Research Institute,

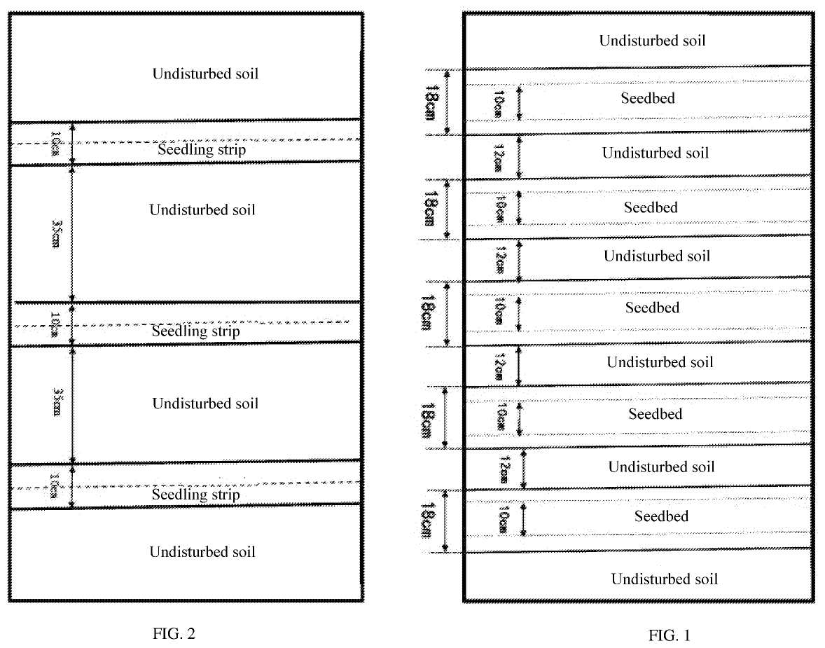

Shandong Academy of Agricultural Sciences from 2018 to 2019. The winter wheat in this example was seeded immediately after the corn was harvested on Oct. 2, 2018. 2BMF Wheat No-tillage Planter (Shandong Dahua Machinery Co., Ltd.) was used. The technical parameters of wheat planting were as follows: the subsoiling depth of seedbed was 28 cm; the finishing depth of seedbed was 12 cm; for seedbed finishing standard, the bulk density of 12 cm soil was preferably 1.1-1.2 g/cm³, and the soil total porosity was 54-56%; the seedbed width was 18 cm, two rows of wheat were seeded in the seedbed, with a row spacing of 10 cm; single side or both sides of the seedbed were undisturbed soil, with a width of 12 cm, as shown in FIG. 1; the wheat seeding depth was 4 cm; the fertilization depth of seed fertilizer was 10 cm, and the fertilizer was applied 3 cm lateral to a wheat seed.

The conventional production technology was seeding after finishing the farmland on Oct. 12, 2018. The conventional production technology included eight processes: rotary tillage for straw chopping after corn harvest, farmland ploughing, spreading of seed fertilizer, rotary tillage for soil crushing, leveling, bedding, seeding, and tamping. The wheat of this example was harvested after full ripeness on Jun. 7, 2019; for the conventional production technology, the wheat was harvested after full ripeness on Jun. 5, 2019.

In this example, the corn was leveled and seeded in a seedbed on June 8. The planter was a Lovol MaterMacc vacuum precision planter. The subsoiling depth of corn seedbed was 20 cm, and a row of corn was seeded in the seedbed; the seedbed width was 10 cm; single side or both sides of the seedbed were undisturbed soil, with a width of 35 cm and an equal row spacing of 45 cm, as shown in FIG. 2; the finishing depth of seedbed was 8 cm; for the seedbed finishing standard, the bulk density of 8 cm soil was preferably 1.1-1.2 g/cm³, and the soil total porosity was 54-56%; the corn seeding depth was 3 cm, the fertilization depth of seed fertilizer was 15 cm, and the fertilizer was just applied below the corn seed. The conventional production technology used direct stubble seeding. That year, corns were harvested after full ripeness on October 4 and 6, respectively.

Investigation, statistics and calculation were conducted on light and temperature resource utilization efficiency, corn germination rate, wheat yield, corn yield, and production cost; the results are shown in Table 1.

TABLE 1
Comparison of light and temperature resource utilization efficiency,
corn germination rate, wheat yield, corn yield, and production cost
obtained by two production technologies

| | Light and | | | | |
|---|---|---|---|---|---|
| | temperature | Corn | | | |
| | resource | germi- | | | Pro- |
| | utilization | nation | Wheat | Corn | duction |
| | efficiency | rate | yield | yield | cost |
| Conventional | 4.3% | 82% | 538 kg/mu | 618 kg/mu | RMB 458 |
| production | | | | | yuan/mu |
| technology | | | | | |
| Example 1 | 10.6% | 98% | 581 kg/mu | 729 kg/mu | RMB 267 |
| | | | | | yuan/mu |

From Table 1, compared Example 1 with the conventional production technology, there are a 6.3% increase in light and temperature resource utilization efficiency, a 16% increase in corn germination rate, a 7.9% increase in wheat yield, a 17.9% increase in corn yield, and a 41.7% reduction in production cost. In terms of product quality, wheat and corn grains produced according to the method of Example 1 are fuller and the product quality is more excellent.

### EXAMPLE 2

The example was carried out in Yueyang Agricultural Specialized Farmer Cooperative, Mazhuang, Tai'an, Shandong Province from 2018 to 2019. The winter wheat was seeded immediately after the corn was harvested on Oct. 5, 2018. 2BMF Wheat No-tillage Planter (Shandong Dahua Machinery Co., Ltd.) was used. The technical parameters of wheat planting were as follows: the subsoiling depth of seedbed was 28 cm; the finishing depth of seedbed was 12 cm; for seedbed finishing standard, the bulk density of 12 cm soil was preferably 1.1-1.2 g/cm³, and the soil total porosity was 54-56%; the seedbed width was 18 cm, two rows of wheat were seeded in the seedbed, with a row spacing of 10 cm; single side or both sides of the seedbed were undisturbed soil, with a width of 12 cm; the wheat seeding depth was 4 cm; the fertilization depth of seed fertilizer was 10 cm, and the fertilizer was applied 3 cm lateral to a wheat seed. The conventional production technology was seeding after finishing the farmland on October 13, 2018. The conventional production technology included eight processes: rotary tillage for straw chopping after corn harvest, farmland ploughing, spreading of seed fertilizer, rotary tillage for soil crushing, leveling, bedding, seeding, and tamping. The wheat of this example was harvested after late ripening on Jun. 10, 2019; for the conventional production technology, the wheat was harvested after late ripening on Jun. 7, 2019.

In this example, the corn was leveled and seeded in a seedbed on June 11. The planter was a Lovol MaterMacc vacuum precision planter. The subsoiling depth of corn seedbed was 20 cm, and a row of corn was seeded in the seedbed; the seedbed width was 10 cm; single side or both sides of the seedbed were undisturbed soil, with a width of 35 cm and an equal row spacing of 45 cm; the finishing depth of seedbed was 8 cm; for the seedbed finishing standard, the bulk density of 8 cm soil was preferably 1.1-1.2 g/cm³, and the soil total porosity was 54-56%; the corn seeding depth was 3 cm, the fertilization depth of seed fertilizer was 15 cm, and the fertilizer was just applied below the corn seed. The conventional production technology used direct stubble seeding. That year, corns were harvested after full ripeness on October 5 and 12, respectively.

Investigation, statistics and calculation were conducted on light and temperature resource utilization efficiency, corn germination rate, wheat yield, corn yield, and production cost; the results are shown in Table 2.

TABLE 2
Comparison of light and temperature resource utilization efficiency,
corn germination rate, wheat yield, corn yield, and production cost
obtained by two production technologies

| | Light and | | | | |
|---|---|---|---|---|---|
| | temperature | Corn | | | |
| | resource | germi- | | | |
| | utilization | nation | Wheat | Corn | Production |
| | efficiency | rate | yield | yield | cost |
| Conventional | 4.1% | 80% | 525 | 603 | RMB 462 |
| production | | | kg/mu | kg/mu | yuan/mu |
| technology | | | | | |
| Example 2 | 9.2% | 97% | 573 | 715 | RMB 278 |
| | | | kg/mu | kg/mu | yuan/mu |

From Table 2, compared Example 2 with the conventional production technology, there are a 5.1% increase in light and temperature resource utilization efficiency, a 17% increase in corn germination rate, a 9.1% increase in wheat yield, an 18.5% increase in corn yield, and a 39.8% reduction in production cost. In terms of product quality, wheat and corn grains produced according to the method of Example 2 are fuller and the product quality is more excellent.

The foregoing examples are preferred implementations of the present disclosure, but the implementations of the present disclosure are not limited by the foregoing examples, and any other changes, modifications, substitutions, combinations, and simplifications made without departing from the spirit and principle of the present disclosure should be equivalent replacement methods, and fall within the protection scope of the present disclosure.

What is claimed is:

1. A simplified cultivation method without wheat-corn rotation system, wherein the method comprises the following steps:
directly planting corn with minimal tillage under no soil ploughing but straw mulching after corn harvest, and directly planting wheat with minimal tillage under no soil ploughing but straw mulching after wheat harvest, thereby realizing zero crop rotation in annual wheat-corn planting, making the most of light and temperature resources and increasing regional annual grain yield.

2. The method according to claim 1, wherein a process after corn harvest in conventional production is changed to one-step process of leveling and seeding in a wheat seedbed; for corn planting, conventional direct stubble seeding of corn is changed to leveling and seeding in a corn seedbed.

3. The method according to claim 2, wherein the wheat is seeded on the day or the next day after corn harvest; and the corn is seeded on the day or the next day after wheat harvest.

4. The method according to claim 3, wherein the wheat is seeded on the day after corn harvest; and the corn is seeded on the day after wheat harvest.

5. The method according to claim 2, wherein a no-tillage fertile-seeding drill is used for completing the process of leveling and seeding in the wheat seedbed; preferably, 2BMF Wheat No-tillage Planter is used.

6. The method according to claim 1, wherein technical parameters of wheat planting are as follows: subsoiling depth of seedbed is 27-29 cm; finishing depth of seedbed is 11-13 cm; seedbed width is 17-19 cm; two rows of wheat are seeded in the seedbed, with a row spacing of 9-11 cm; both sides of the seedbed are undisturbed soil, with a width of 11-13 cm; wheat seeding depth is 3.5-4.5 cm; fertilization depth of seed fertilizer is 9-11 cm, and the fertilizer is applied 2.5-3.5 cm lateral to a wheat seed;
seedbed finishing standard means that bulk density of 11-13 cm deep soil is preferably 1.1-1.2 g/cm³, and total soil porosity is 54-56%.

7. The method according to claim 6, wherein the technical parameters of wheat planting are as follows: the subsoiling depth of seedbed is 28 cm; the finishing depth of seedbed is 12 cm; the seedbed width is 18 cm; two rows of wheat are seeded in the seedbed, with a row spacing of 10 cm; single side or both sides of the seedbed are undisturbed soil, with a width of 12 cm; the wheat seeding depth is 4 cm; the fertilization depth of seed fertilizer is 10 cm, and the fertilizer is applied 3 cm lateral to a wheat seed.

8. The method according to claim 1, wherein a no-tillage fertile-seeding drill is used for completing the leveling and seeding in the corn seedbed;
preferably, a Lovol MaterMacc vacuum precision planter is used.

9. The method according to claim 1, wherein technical parameters of corn planting are as follows: subsoiling depth of corn seedbed is 19-21 cm; a row of corn is seeded in the seedbed; seedbed width is 9-11 cm; single side or both sides of the seedbed are undisturbed soil, with a width of 34-36 cm; row spacing of corn is 44-46 cm; finishing depth of seedbed is 7-9 cm; corn seeding depth is 2.5-3.5 cm; fertilization depth of seed fertilizer is 14-16 cm, and the fertilizer is just applied below the corn seed; seedbed finishing standard means that bulk density of 7-9 cm deep soil is preferably 1.1-1.2 g/cm³, and total soil porosity is 54-56%;
preferably, the fertilizer is a slow-release fertilizer.

10. The method according to claim 1, wherein the technical parameters of corn planting are as follows: the subsoiling depth of corn seedbed is 20 cm; a row of corn is seeded in the seedbed; the seedbed width is 10 cm; single side or both sides of the seedbed are undisturbed soil, with a width of 35 cm; the row spacing of corn is 45 cm; the finishing depth of seedbed is 8 cm; the corn seeding depth is 3 cm; the fertilization depth of seed fertilizer is 15 cm.
